(19) United States
(12) Patent Application Publication
(10) Pub. No.: US 2017/0129140 A1
(43) Pub. Date: May 11, 2017

(54) FORMING TOOL OF A PREFORM IN COMPOSITE MATERIAL AND METHOD OF MANUFACTURING A PART IN COMPOSITE MATERIAL USING SAID TOOL

(71) Applicant: Airbus Operations SAS, Toulouse (FR)

(72) Inventor: Gautier DESTOMBES, Nantes (FR)

(21) Appl. No.: 15/345,869

(22) Filed: Nov. 8, 2016

(30) Foreign Application Priority Data
Nov. 9, 2015 (FR) 1560697

(51) Int. Cl. B29C 31/00; B29B 11/14

(52) U.S. Cl. CPC B29C 31/006; B29B 11/14; B29L 2031/608

(57) ABSTRACT

A forming tool of a preform made of composite material, the tool comprising at least one flexible element and at least a first and a second rigid plate connected to the flexible element and disposed on either side of the flexible element. The first and second rigid plates and the flexible element comprise first, second and third reference surfaces, respectively. The flexible element is configured to allow the tool to occupy a depositing state in which the first, second and third reference surfaces are coplanar and a forming state in which the third reference surface is curved and the first and second reference surfaces are at a desired angle to one another.

### CROSS-REFERENCES TO RELATED APPLICATIONS

This application claims the benefit of the French patent application No. 1560697 filed on Nov. 9, 2015, the entire disclosures of which are incorporated herein by way of reference.

### BACKGROUND OF THE INVENTION

The present invention relates to a forming tool of a preform in composite material and also a method of manufacturing a part in composite material using the tool.

In the description that follows, “preform” is understood to refer to a volume of pre-impregnated fibers which is not completely polymerized. Hence, the volume of pre-impregnated fibers may be non-polymerized or partially polymerized.

Illustrated in FIGS. 1A to 1D are different stages in a manufacturing process of a composite material part according to a first variant of the prior art.

During a first stage illustrated in FIG. 1A, a preform 10 is produced on a first planar, rigid tool 12. A non-stick film is inserted between the preform 10 and the first tool 12 to allow an operator to remove the preform.

During a second forming stage illustrated in FIGS. 1B and 1C, the preform 10 is returned, positioned on a second tool 14 and covered with a first covering 16. In the description that follows, a covering comprises at least one impenetrable membrane, preferably associated with different films and/or layers, such as an unmolding film, for example, a layer to assist with the removal of gases contained in the preform when it is placed in a vacuum.

The first covering 16 is connected to the second tool 14 in an impenetrable manner, so as to delimit an impenetrable volume. Next, the preform 10 is heated and a vacuum is created in the volume delimited by the second tool 14 and the first tool 16. As illustrated in FIG. 1C, the first covering 16 presses a portion of the preform 10 against the second tool 14, in order to obtain an L-shaped preform.

Following deformation, the first covering 16 is removed and the preform 10 is positioned in a third tool 18, then covered with a second covering 20, as illustrated in FIG. 1D, in order to polymerize the composite material part.

There are several disadvantages associated with this method of manufacturing a composite material part which comprises a forming stage:

The transfer of the preform 10 from one tool to the other involves a loss of reference which is translated as dimensional inaccuracies in the part thereby produced;

The installation of the first covering 16 during the forming stage is relatively longwinded and complex;

The configuration of certain characteristics of the forming method is complex.

According to a second variant of the prior art, the forming stage is realized using a folding machine, in order to simplify the configuration and overcome the need to install the first covering 16. However, this second variant can only be implemented for preforms with a constant thickness.

The present invention is intended to address the disadvantages of the prior art.

### SUMMARY OF THE INVENTION

To this end, an object of the invention is a forming tool of a preform in composite material, the tool being characterized in that it comprises at least one flexible element and at least a first and a second rigid plate connected to the flexible element and disposed on either side of the flexible element, the first and second rigid plates and the flexible element comprising first, second and third reference surfaces, respectively, the tool being adapted to receive the composite material preform on the first, second and third reference surfaces, the flexible element being configured, moreover, to allow the tool to occupy:

a first state, known as the depositing state, in which the first, second and third reference surfaces are coplanar,

a second state, known as the forming state, in which the third reference surface is curved and the first and second reference surfaces are at a desired angle to one another.

The tool according to the invention allows:

a single preform production stage to be retained, to the extent that the preform is produced on a planar reference surface,

certain transfers of the preform to be eliminated and the placement of a covering during the forming stage to be simplified, so that, specifically, a substantial time-saving can be made and production costs reduced,

better control of the parameters (kinematic and kinetic) of the forming process to be guaranteed,

the same surface to be retained as the reference surface throughout the manufacturing process of the composite material part, which allows the dimensional and geometric accuracy of the part obtained to be improved.

The flexible element preferably has mechanical and geometric properties that allow it to deform in a transverse plane along a circular arc which extends from the first rigid plate up to the second rigid plate.

Advantageously, the flexible element has a thickness of between 0.2 mm and 0.7 mm.

According to one embodiment, the first and second rigid plates each comprise a honeycomb structure inserted between a first wall and a second wall, the flexible element comprising a third wall and the first walls of the two rigid plates and the third wall of the flexible element being one and the same wall.

According to another characteristic, the tool comprises a pivoting system configured to make the first and second rigid plates pivot one in respect of the other, so as to achieve the desired angle.

The pivoting system preferably comprises a first extension connected to the first rigid plate and a second extension connected to the second rigid plate, the first and second extensions being spaced apart from the flexible element and comprising first and second free ends, respectively, positioned above the first, second and third reference surfaces, the pivoting system comprising an actuator configured to cause at least a convergence of the first and second free ends.

According to an embodiment, the pivoting system comprises a cable connected to the first free end, a cable guide connected to the second free end and configured to guide the cable, the actuator being configured to exert a tractive force on the cable.

An object of the invention is a method of manufacturing a part in composite material from a preform, the method comprising a preform production stage, a preform forming stage and a polymerization stage aimed at hardening the preform to obtain the composite material part, the preform production and forming stages, at least, being realized using a tool according to the invention.

The tool is preferably used for the polymerization stage and the tool comprises a pivoting system to change by iteration the angle formed by the first and second rigid plates.

### BRIEF DESCRIPTION OF THE DRAWINGS

Other characteristics and advantages will emerge from the following description of the invention, a description provided simply by way of example, with regard to the attached drawings in which:

FIGS. 1A to 1D are diagrams of the different stages in a manufacturing method of a composite material part which illustrate the prior art,

FIGS. 2A and 2B are cross sections through a forming tool in the depositing state and in the forming state which illustrate the invention,

FIGS. 3A and 3B are cross sections of a forming tool in the depositing state and in the forming state which illustrate an embodiment of the invention,

FIGS. 4A to 4C are diagrams of different stages in a manufacturing method of a composite material part which illustrate the invention.

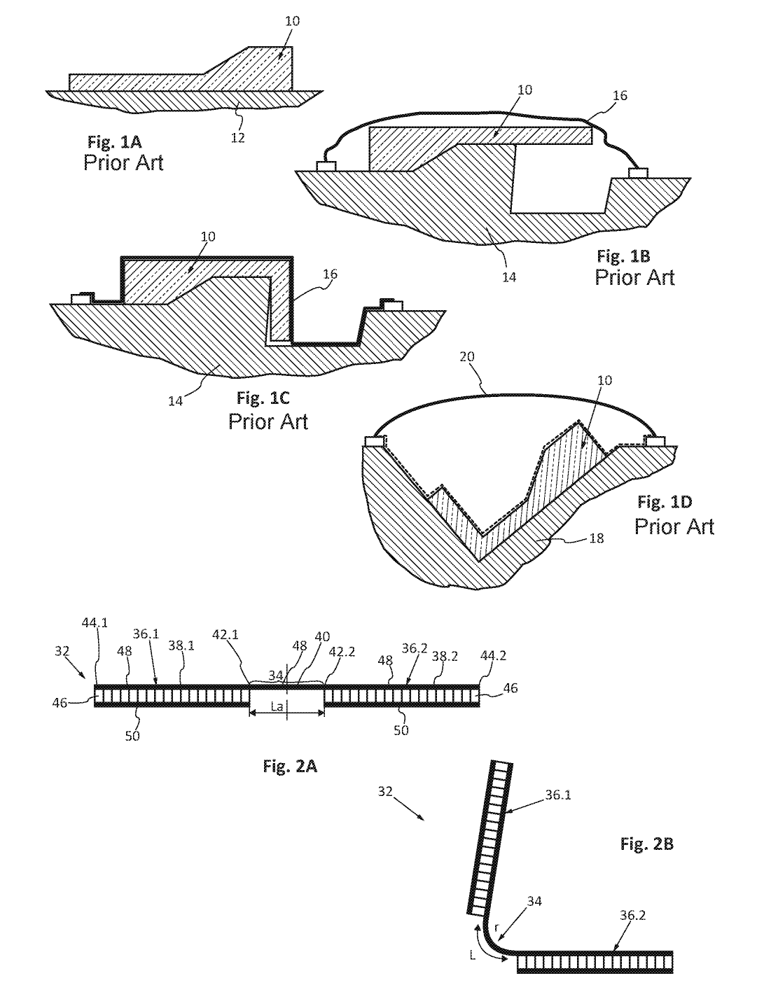

### DETAILED DESCRIPTION OF THE PREFERRED EMBODIMENTS

As illustrated in FIGS. 4A to 4C, a method of manufacturing a composite material part from a preform 22 of pre-impregnated fibers comprises a production stage of the preform 22 (FIG. 4A), a forming stage of the preform 22 (FIG. 4B) and a polymerization stage (FIG. 4C) aimed at hardening the preform 22 to obtain the composite material part.

During a first stage that can be seen in FIG. 4A, the preform 22 is produced on a depositing surface 24. By way of example, the preform 22 is obtained by draping folds of fibers oriented according to a predetermined layout. This first production stage of the preform 22 is not further specified, as it is known to the person skilled in the art.

As illustrated in FIG. 4A, the preform 22 does not have a constant thickness (the thickness corresponding to the dimension of the preform 22 taken in the direction perpendicular to the depositing surface 24). The invention is not, of course, limited to this shape for the preform which may have a constant thickness.

The depositing surface 24 is preferably planar.

During a second stage that can be seen in FIG. 4B, the preform 22 undergoes a forming stage which is aimed at forming at least a folding line 26 in the preform 22.

For a given folding line 26, the preform 22 comprises a first surface 28 in contact with the depositing surface 24 and a second surface 30 in contact with the depositing surface 24 which are disposed on either side of the folding line 26, the first and second surfaces 28 and 30 being coplanar with the forming stage and producing a desired angle A after the forming stage.

In the description that follows, a folding line 26 is a line that corresponds to the intersection of the first and second surfaces 28 and 30. A longitudinal direction is parallel to the folding line 26. A transverse plane is a plane perpendicular to the folding line 26. The width of an element corresponds to the dimension of the element taken in a transverse plane.

According to a characteristic of the invention, a same tool 32 is used for the production and forming stages of the preform.

This tool 22 comprises at least one flexible element 34 which extends along the folding line 26 and at least two rigid plates 36.1 and 36.2 connected to the flexible element 34 and disposed on either side of the flexible element 34. As illustrated in FIG. 26, the first and second rigid plates 36.1 and 36.2 comprise first and second reference surfaces 38.1 and 38.2, respectively, and the flexible element 34 comprises a third reference surface 40.

The flexible element 34 is configured to allow the tool 32 to occupy:

a first state, known as the depositing state, as illustrated in FIGS. 2A, 3A and 4A, in which the first, second and third reference surfaces 38.1, 38.2 and 40 are coplanar and form the depositing surface 24 on which the preform 22 is produced;

a second state, known as the forming state, as illustrated in FIGS. 2B, 3B, 4B, in which the third reference surface 40 is curved and the first and second planar reference surfaces 38.1 and 38.2 are at a desired angle A to one another.

Each rigid plate 36.1, 36.2 comprises a first edge 42.1, 42.2 linked to the flexible element 34 and a second outer edge 44.1, 44.2 distal from the flexible element 34, generally parallel to the first edge 42.1, 42.2.

The flexible element 34 has mechanical and geometric properties allowing it to deform in a transverse plane along a circular arc which extends from the first rigid plate 36.1 to the second rigid plate 36.2, the circular arc having a radius equal to the desired outer radius for the preform 22.

The flexible element 34 preferably has a thickness of between 0.2 mm and 0.7 mm, for a width La in the order of 50 mm and for a given modulus of rigidity which is a function of the value of the radius and the forming angle A.

The flexible element 34 is advantageously impervious so that it can be placed in a vacuum.

The rigid plates 36.1 and 36.2 have a rigidity adapted to guarantee the dimensional tolerances of the preform 22.

According to an embodiment that can be seen in FIGS. 2A and 2B, the rigid plates 36.1 and 36.2 each comprise a honeycomb structure 46 inserted between a first wall 48 and a second wall 50 and the flexible element 34 comprises a third wall 51. The first walls 48 of the two rigid plates 36.1 and 36.2 and the third wall 51 of the flexible element 34 are one and the same wall, the thickness of which is preferably constant and a face of which constitutes the depositing surface 24. Hence, each rigid plate 36.1 and 36.2 has a thickness which is equal to the sum of the thicknesses of the first and second walls 48 and 50 and of the honeycomb structure 46 and the flexible element 34 has a thickness which is equal to the thickness of the third wall 51 which is equal to the thickness of the first wall 48 of the rigid plates 36.1 and 36.2.

According to one embodiment, the flexible element 34 is formed of steel, of composite material based on carbon fibers or of glass fibers. By way of example, the flexible element 34 is a layered body made up of fine folds with a density in the order of 25 gr/m², wisely oriented.

According to one embodiment, the rigid plates 36.1 and 36.2 are made of steel, of composite material based on carbon fiber or fiberglass.

According to another characteristic, the tool 32 comprises a pivoting system 52 configured to make the rigid plates 36.1 and 36.2 pivot one in respect of the other along the folding line 26, in such a manner as to achieve the desired angle A.

According to a first embodiment, the pivoting system 52 comprises a fixed chassis integral with one of the rigid plates and a robotic arm, one end of which is connected to the other rigid plate.

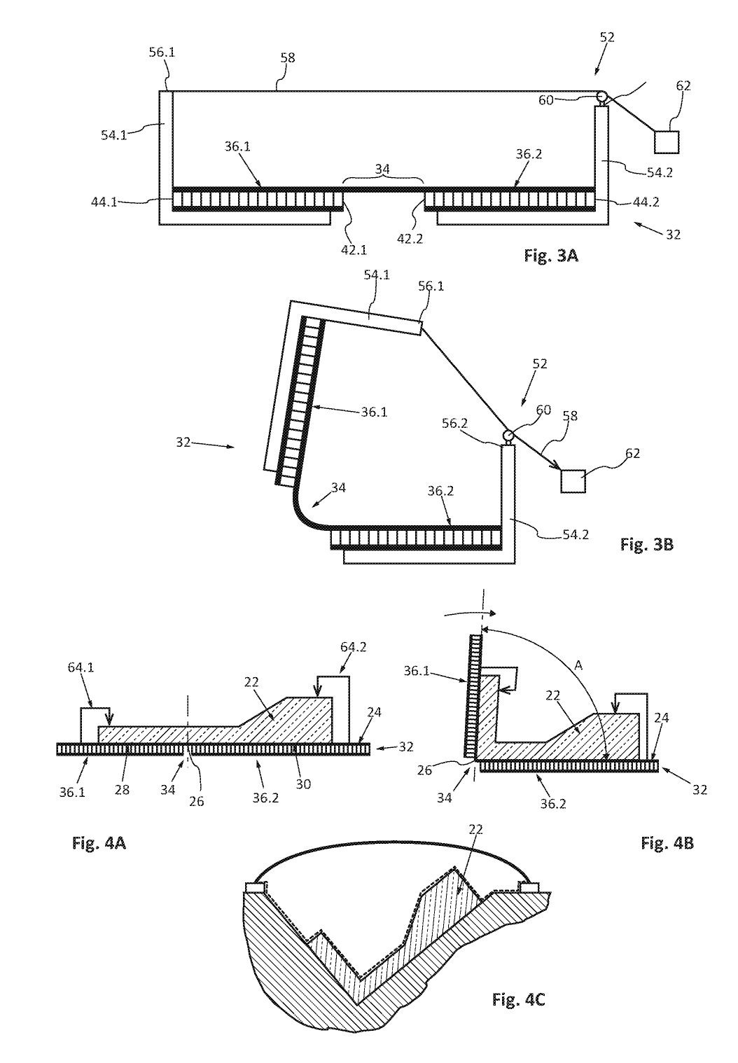

According to a second embodiment that can be seen in FIGS. 3A and 3B, the pivoting system 52 comprises two extensions 54.1, 54.2, a first extension 54.1 connected to the outer edge 44.1 of the first rigid plate 36.1 and a second extension 54.2 connected to the outer edge 44.2 of the second rigid plate 36.2. The first and second extensions 54.1 and 54.2 are spaced apart from the flexible element 34 and comprise first and second free ends 56.1 and 56.2, respectively, positioned above the first, second and third reference surfaces 38.1, 38.2 and 40.

The pivoting system 52 comprises an actuator 62 configured to at least cause the convergence and possible divergence of the first and second free ends 56.1 and 56.2.

According to one embodiment, the actuator 62 is an actuating drive inserted between the two free ends 56.1, 56.2, the actuating drive body being connected to the first free end 56.1 and the actuating drive rod to the second free end 56.2.

According to one embodiment that can be seen in FIGS. 3A and 3B, the pivoting system 52 comprises a cable 58 connected to the first free end 56.1, a cable guide 60 connected to the second free end 56.2 and configured to guide the cable 58. The actuator 62 is a drive configured to exert a tractive force on the cable 58 in such a manner as to cause the convergence of the first and second free ends 56.1 and 56.2, as illustrated in FIG. 3B.

Advantageously, the tool 32 comprises a heating system for heating the preform 22. According to an embodiment, the heating system comprises heating elements such as, for example, electrical resistors integrated in the rigid plates 36.1 and 36.2 and the flexible element 34.

Advantageously, the tool 32 is used to realize the polymerization stage.

To this end, the tool 32 is configured to withstand polymerization temperatures in the order of 200° C.

According to a first variant, the pivoting system 52 allows the closing angle of the tool 32, which corresponds to the angle formed by the two rigid plates 36.1 and 36.2, to be changed by iteration during the polymerization stage.

According to a second variant, for the polymerization stage, the tool 32 is positioned in a jig which comprises two portions connected by a joint, each portion being joined to a rigid plate 36.1 and 36.2 of the tool 32, the joint being adjustable in order to allow the angular closure of the tool 32 to be changed by iteration.

According to a third variant that can be seen in FIG. 4C, for the polymerization stage, the preform 22 is removed from the tool 32 to be positioned in a dedicated polymerization tool 64 which is identical to the polymerization tools of the prior art.

The tool 32 preferably comprises a flange system to keep the preform 22 immobile with respect to the two rigid plates 36.1 and 36.2. The flange system advantageously comprises a first flange 64.1 integral with the first rigid plate 36.1, configured to hold a first edge of the preform 22 and a second flange 62.2 integral with the second rigid plate 36.2, configured to hold a second side of the preform 22.

The tool 32 brings with it the following advantages:

It allows better control to be gained of the parameters (kinematic and kinetic) of the forming process. Hence, the forming speed (which corresponds to the speed of the angular movement of one of the rigid plates in respect of the other) can be reduced. This makes it possible to realize the forming stage at a temperature which is lower and therefore less constraining than those of the methods in the prior art.

The tool 32 makes it possible to produce the preform flat, which simplifies the production process of the preform 22.

The tool 32 makes it possible to simplify the placement of a covering during the forming stage, the forming being undertaken in a controlled vacuum in such a manner as to guarantee a constant consolidation level in the preform 22 and close contact between the preform and the tool.

The tool 32 allows certain transfers of the preform 22, in some cases all transfers, to be eliminated when the tool 32 is configured to realize the polymerization stage. Hence, the tool 32 allows a significant time-saving to be made and enables production costs to be reduced.

Finally, the tool 32 allows the same surface to be retained as the reference surface throughout the manufacturing process, which allows the dimensional and geometric accuracy of the part obtained to be improved.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A forming tool of a preform in composite material, said tool comprising:
at least one flexible element and
at least a first and a second rigid plate connected to the flexible element and disposed on either side of the flexible element,
the first and second rigid plates and the flexible element comprising first, second and third reference surfaces, respectively,
the tool being adapted to receive the composite material preform on the first, second and third reference surfaces,
the flexible element being configured, moreover, to allow the tool to occupy:
a first state, known as the depositing state, in which the first, second and third reference surfaces are coplanar, and
a second state, known as the forming state, in which the third reference surface is curved and the first and second reference surfaces are at a desired angle to one another.

2. The tool according to claim 1, wherein the flexible element has mechanical and geometric properties that allow the flexible element to deform in a transverse plane along a circular arc which extends from the first rigid plate up to the second rigid plate.

3. The tool according to claim 1, wherein the flexible element has a thickness of between 0.2 mm and 0.7 mm.

4. The tool according to claim 1, wherein the first and second rigid plates each comprise a honeycomb structure inserted between a first wall and a second wall, wherein the flexible element comprises a third wall and wherein the first walls of the two rigid plates and the third wall of the flexible element are one and the same wall.

5. The tool according to claim 1, further comprising a pivoting system configured to make the first and second rigid plates pivot with respect to each other, so as to achieve the desired angle.

6. The tool according to claim 5, wherein the pivoting system comprises a first extension connected to the first rigid plate and a second extension connected to the second rigid plate, the first and second extensions being spaced apart from the flexible element and comprising first and second free ends, respectively, positioned above the first, second and third reference surfaces, the pivoting system comprising an actuator configured to cause at least a convergence of the first and second free ends.

7. The tool according to claim 6, wherein the pivoting system comprises a cable connected to the first free end, a cable guide connected to the second free end and configured to guide the cable and wherein the actuator is configured to exert a tractive force on the cable.

8. The tool according to claim 1, further comprising a heating system comprising heating elements integrated in the first and second rigid plates.

9. A method of manufacturing a part in composite material from a preform, said method comprising:
producing a preform in a preform production stage,
forming the preform in a preform forming stage and
hardening the preform in a polymerization stage to obtain the composite material part,
at least the preform production and forming stages utilizing a tool comprising:
at least one flexible element and
at least a first and a second rigid plate connected to the flexible element and disposed on either side of the flexible element,
the first and second rigid plates and the flexible element comprising first, second and third reference surfaces, respectively,
the tool being adapted to receive the composite material preform on the first, second and third reference surfaces,
the flexible element being configured, moreover, to allow the tool to Occupy:
a first state, known as the depositing state, in which the first, second and third reference surfaces are coplanar, and
a second state, known as the forming state, in which the third reference surface is curved and the first and second reference surfaces are at a desired angle to one another.

10. The method according to claim 9, wherein the tool is also used for the polymerization stage and wherein the tool comprises a pivoting system to change by iteration the angle formed by the first and second rigid plates.
